(19) United States
(12) Patent Application Publication
(10) Pub. No.: US 2018/0094429 A1
(43) Pub. Date: Apr. 5, 2018

(54) SYSTEMS FOR INSULATING PANELS IN HEATING, VENTILATING, AND AIR CONDITIONING APPLICATIONS

(71) Applicant: Johnson Controls Technology Company, Plymouth, MI (US)

(72) Inventors: Nicholas P. Mislak, Bel Air, MD (US); Douglas A. Kester, West York Borough, PA (US)

(21) Appl. No.: 15/611,594

(22) Filed: Jun. 1, 2017

Related U.S. Application Data
(60) Provisional application No. 62/404,666, filed on Oct. 5, 2016.

(51) Int. Cl. E04B 1/80; E04C 2/34; B32B 27/06

(52) U.S. Cl. CPC E04B 1/803; E04C 2/34; B32B 27/065; C08J 2205/026; F17C 2203/0358; F17C 2203/0391; E04B 1/80

(57) ABSTRACT

A heating, ventilation, and air conditioning (HVAC) unit is provided. The HVAC unit includes a cabinet that has a boundary that defines an interior volume, and HVAC components are situated within the interior volume. Additionally, the HVAC unit includes a panel that forms part of the boundary, and the panel includes an aerogel material.

### CROSS REFERENCE TO RELATED APPLICATIONS

This application claims priority from and the benefit of U.S. Provisional Application Ser. No. 62/404,666, entitled “INSULATED PANELS USING AEROGEL,” filed Oct. 5, 2016, which is hereby incorporated by reference.

### BACKGROUND

The present disclosure relates generally to heating, ventilating, and air conditioning systems.

A wide range of applications exist for heating, ventilating, and air conditioning (HVAC) systems. For example, residential, light commercial, commercial, and industrial systems are used to control temperatures and air quality in residences and buildings. Such systems often are dedicated to either heating or cooling, although systems are common that perform both of these functions. Very generally, these systems operate by implementing a thermal cycle in which fluids are heated and cooled to provide the desired temperature in a controlled space, typically the inside of a residence or building. Similar systems are used for vehicle heating and cooling, and as well as for general refrigeration.

HVAC units, such as air handlers, heat pumps, and air conditioning units, are used to provide heated, cooled, and/or dehumidified air to conditioned environments. Additionally, HVAC units may include panels that may protect components of the HVAC unit and/or provide structural support for the HVAC units. For example, the panels may be part of a housing or cabinet that surrounds the internal components. In many HVAC units, foam and/or fiberglass insulation is included within the panels. For instance, the panels may typically include two walls, and the insulation may be positioned between the two walls.

### SUMMARY

The present disclosure relates to a heating, ventilation, and air conditioning (HVAC) unit that includes a cabinet that defines an interior volume, and HVAC components are situated within the interior volume. The HVAC unit also includes a panel that forms part of the boundary, and the panel includes an aerogel material.

The present disclosure also relates to a heating, ventilation, and air conditioning (HVAC) enclosure that includes a panel. The panel includes a first structural wall that includes a first surface. The panel also includes an insulative material coupled to the first surface of the first structural wall. The insulative material includes an aerogel.

The present disclosure further relates to a heating, ventilation, and air conditioning (HVAC) unit that includes an enclosure. The enclosure includes an enclosure that includes a plurality of panels. The plurality of panels defines an interior volume, and each panel of the plurality of panels includes an aerogel material coupled to the respective panel. The HVAC unit also includes a condenser and an evaporator, both of which are disposed within the interior volume of the enclosure. The evaporator is coupled to the condenser and is configured to receive a refrigerant from the condenser. Additionally, the HVAC unit includes a fan disposed within the interior volume of the enclosure. The fan is configured to draw environmental air into the HVAC unit.

### DRAWINGS

FIG. 1 is a perspective view a heating, ventilating, and air conditioning (HVAC) system for building environmental management, in accordance with embodiments described herein;

FIG. 2 is a perspective view of the HVAC unit of FIG. 1, in accordance with embodiments described herein;

FIG. 3 is a perspective view of a residential heating and cooling system, in accordance with embodiments described herein;

FIG. 4 is a schematic view of a vapor compression system that may be used in the HVAC system of FIG. 1 and the residential heating and cooling system FIG. 3, in accordance with embodiments described herein;

FIG. 5 is a front elevation view of a panel of the cabinet of the HVAC unit of FIG. 2, in accordance with embodiments described herein;

FIG. 6 is a cross-sectional view of a panel of an HVAC unit, in accordance with embodiments described herein;

FIG. 7 is a cross-sectional view of a panel of an HVAC unit, in accordance with embodiments described herein;

FIG. 8 is a perspective view of a panel of an HVAC unit with a portion of a wall of the panel removed, in accordance with embodiments described herein; and

FIG. 9 is a flow chart of a method for assembling a panel of an HVAC unit, in accordance with embodiments described herein.

### DETAILED DESCRIPTION

The present disclosure is directed to heating, ventilating, and air conditioning (HVAC) systems that include panels insulated with aerogel. More specifically, HVAC units in HVAC systems may include double-walled panels with aerogel disposed between the two walls of the panel or single-walled panels with aerogel coupled to the single wall of the panel. Using aerogel as insulation in the panels reduces the weight of the HVAC units, and in embodiments in which the panels are single-walled, there is an even greater reduction weight due to the panel only including a single wall instead of two walls.

Aerogel is a lightweight material typically derived from various types of gel. More specifically liquid in a gel may be replaced by gas to form aerogel. Many types of aerogel may be used for the applications discussed below. For example, aerogel may be a silica aerogel (i.e., derived from silica), a metal oxide aerogel (i.e., derived from a metal oxide), or carbon aerogel (i.e., derived from a carbon compound, such as an organic compound). Also, in addition to being lightweight, aerogel has a low density, but is strong and highly thermally insulative. Thus, a volume of aerogel smaller than the volume of fiberglass and foam insulation typically used in HVAC systems may be used to provide insulation to HVAC systems.

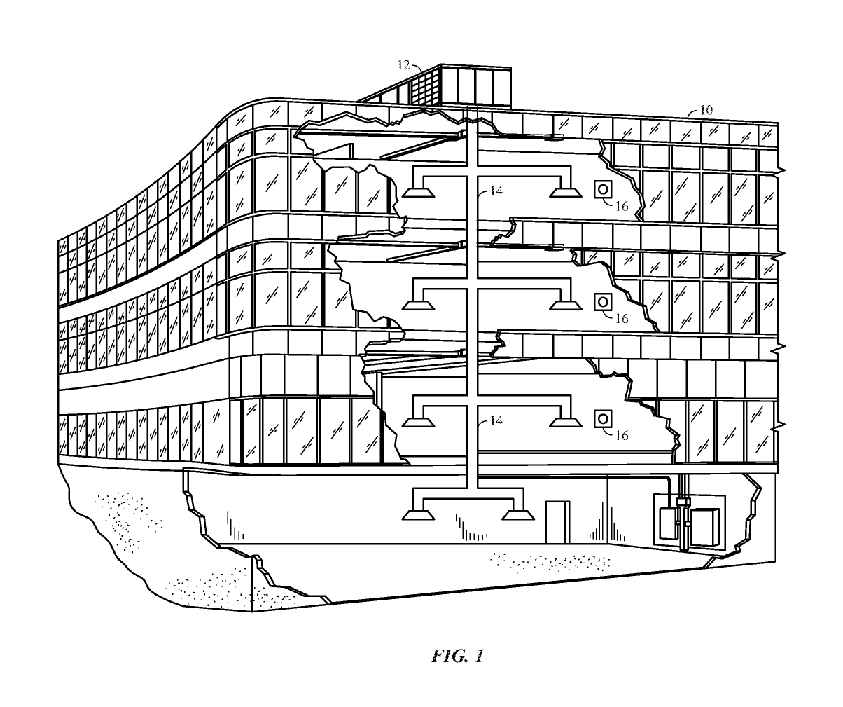

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

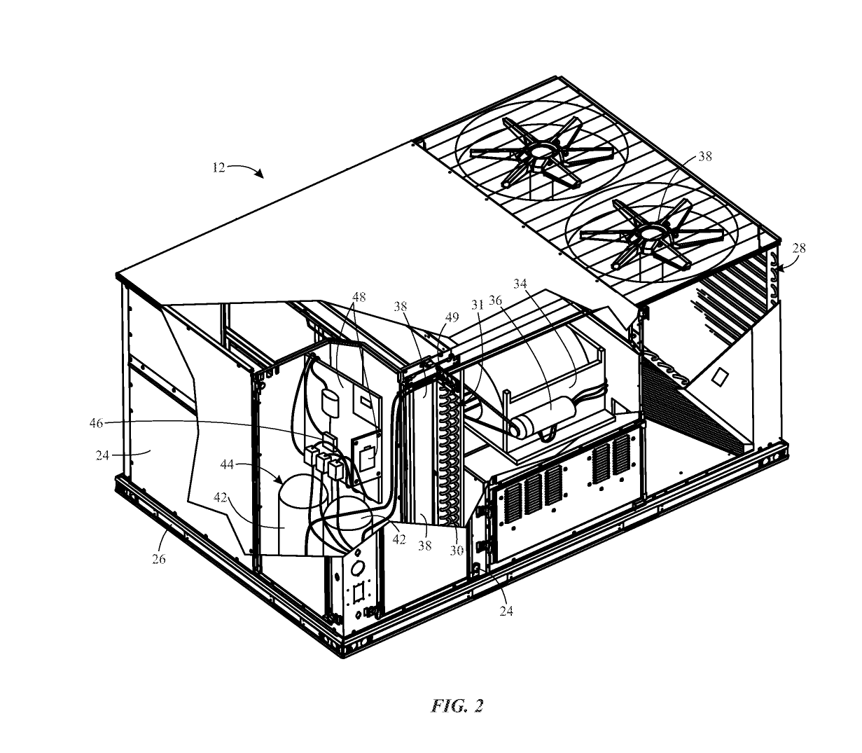

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

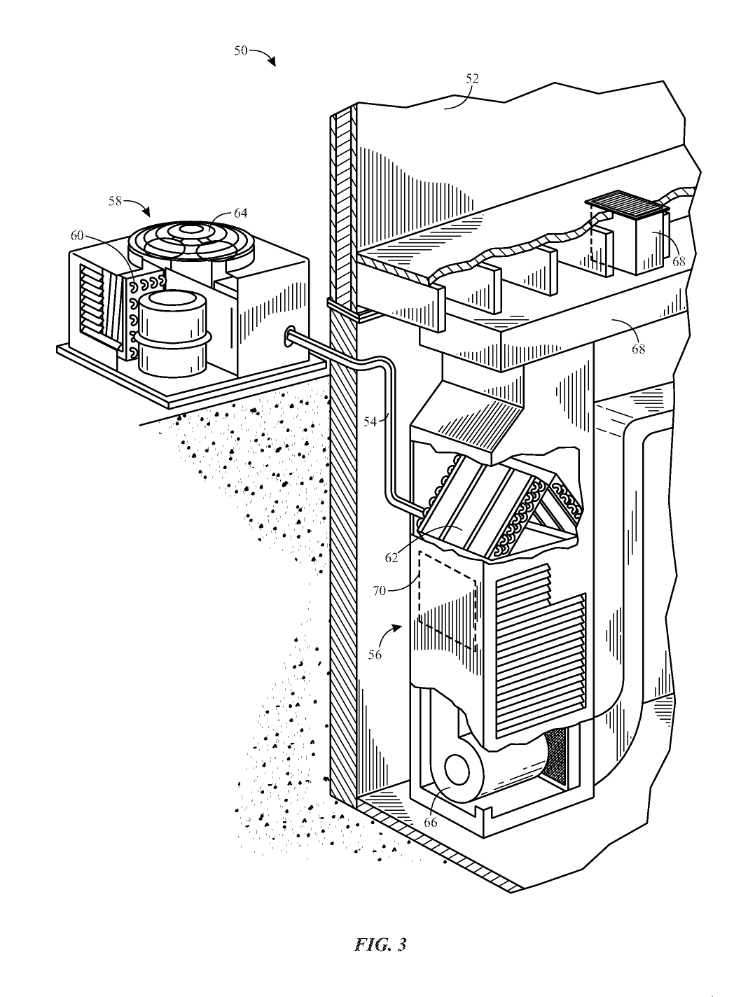

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, insulation may be included in panels of HVAC units (e.g., HVAC unit 12). As discussed below, the panels of the cabinet 24 of the HVAC unit 12 may include aerogel that insulates the interior of the HVAC unit 12 from areas outside of the HVAC unit 12. More specifically, HVAC units in HVAC systems may include double-walled panels with aerogel disposed between the two walls of the panel or single-walled panels with aerogel coupled to the single wall of the panel. Using aerogel as insulation in the panels reduces the weight of the HVAC units, and in embodiments in which the panels are single-walled, there is an even greater reduction weight due to the panel only including a single wall instead of two walls.

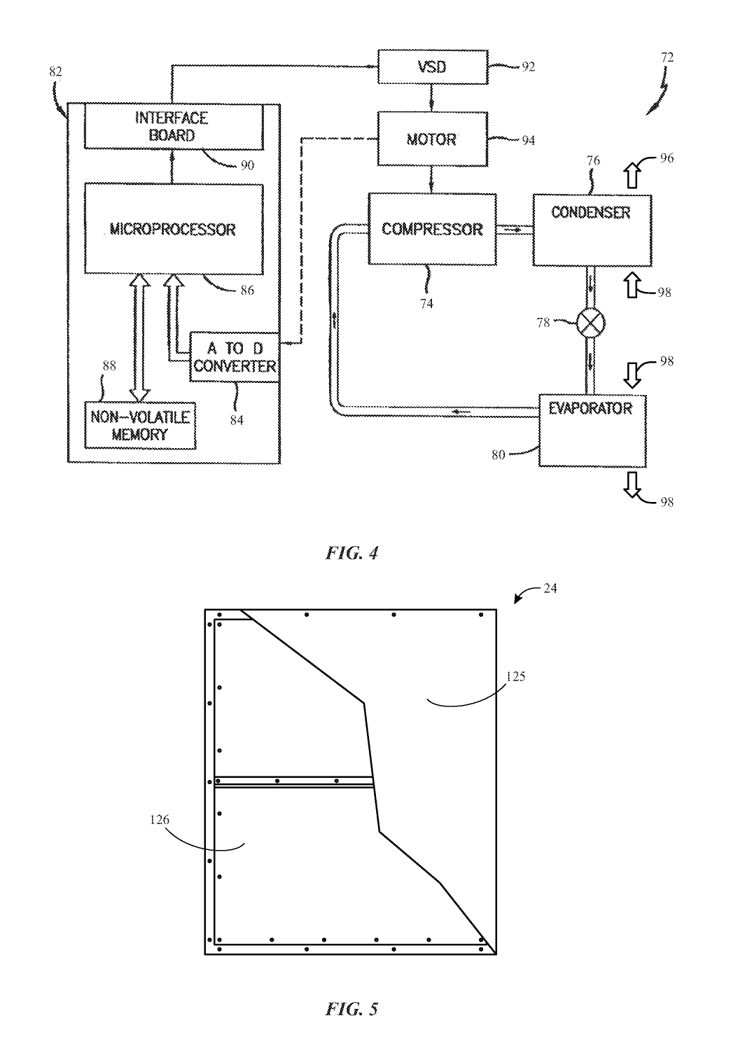

FIG. 5 is a front elevation view of a panel 124 of the HVAC unit 12 of FIG. 2. The cabinet 24 of the HVAC unit 12 may include panels (e.g., panel 124) that define an interior volume of the cabinet 24, and components of the HVAC unit 12 may be included within the interior volume. In other words, the cabinet 24 forms a boundary that defines an interior volume that includes components of the HVAC unit 12. As illustrated, the panel 124 is double-walled. Thus, each panels 24 of the cabinet may include an outer wall 125 (e.g., a first structural wall) and an inner wall 126 (e.g., a second structural wall), which may be mechanically connected to one another via rivets. Aerogel may be disposed between the outer wall 125 and the inner wall 126 and may insulate the interior of the HVAC unit 12 from environmental temperatures. For example, the aerogel insulation may insulate the HVAC unit 12 from cold temperatures during the winter when the HVAC unit 12 may be used to provide heating, and the aerogel insulation may insulate the HVAC unit 12 from warm temperatures during the summer when the HVAC unit 12 may be used to provide cooling.

The aerogel may be coupled (e.g., via an adhesive) to the outer wall 125, the inner wall 126, or both the outer wall 125 and the inner wall 126. Additionally, or in the alternative, a mechanical fastener coupling the outer wall 125 and the inner wall 126 may be used to secure the aerogel in place. Furthermore, in some embodiments, the aerogel may be sandwiched between and/or completely encased within the outer wall 125 and the inner wall 126 in a manner such that the aerogel may not be held in place by an adhesive or the mechanical fastener that couples the outer wall 125 to the inner wall 126. It should also be noted that, as discussed below, in some embodiments, the cabinet 24 may include panels 124 that are single-walled yet still insulate the HVAC unit 12.

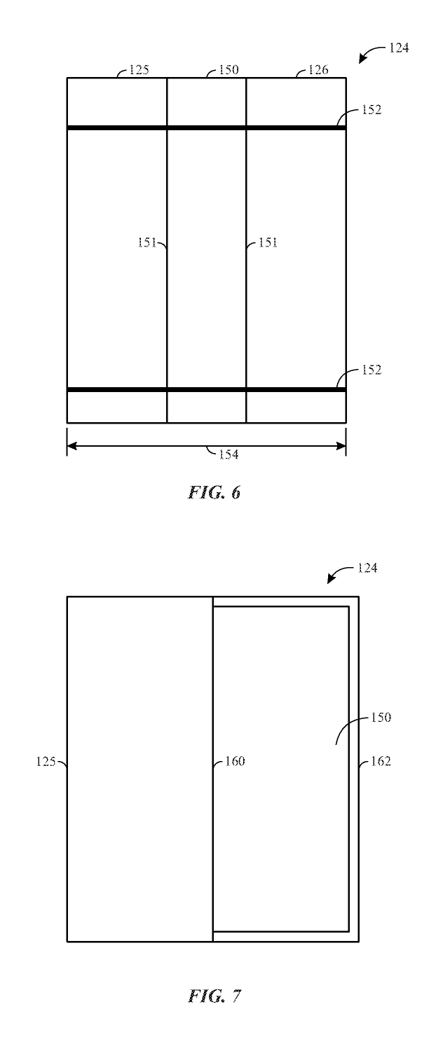

With the cabinet 24, panels 124, outer wall 125, and inner wall 126 in mind, FIG. 6 is a cross-sectional view of an embodiment of the panel 124 that may be used in the HVAC unit 12. More specifically, as illustrated, the panel 124 is a double-walled panel that includes aerogel 150 (e.g., an aerogel material) between interior surfaces 151 of the inner wall 126 and the outer wall 125. Additionally, outer wall 125, inner wall 126, and the aerogel 150 may be coupled to one another via mechanical fasteners, such as rivets 152. However, it should be noted that the aerogel 150 be kept in between the outer wall 125 and the inner wall 126 via other configurations. For example, the aerogel may be placed between the outer wall 125 and the inner wall 126, and the outer wall 125 and the inner wall 126 may be welded together. Moreover, as an alternative to mechanical fasteners or in addition to mechanical fasteners, the aerogel 150 may be coupled to either or both of the interior surfaces 151 of the inner wall 126 and the outer wall 125 via an adhesive (e.g., glue). In any case, the panel 124 may be vacuum-sealed and/or the aerogel 150 may be treated such that it is waterproof and/or isolated from potential sources of water.

It should also be noted that the illustrated embodiment of the panel 124 may be thinner that typical double-walled panels that include forms of insulation other than aerogel. More specifically, a thickness 154 of the panel 124 may be less than a thickness of another panel that includes another type of insulation because aerogel can provide similar or superior insulative properties with a smaller amount of material than foam and fiberglass insulation. The reduction in the thickness 154 of the panel may also allow for the HVAC units to be smaller and more lightweight than HVAC units that include insulative materials other than aerogel.

FIG. 7 is a cross-sectional view of another embodiment of the panel 124 that may be included in the HVAC unit 12. More specifically, the panel 124 is a single-walled panel that includes the outer wall 125 and aerogel 150. The aerogel 150 may be coupled to the outer wall 125 via an adhesive 160 (e.g., glue). Additionally, the aerogel 150 may be waterproofed. For example, the aerogel 150 may be treated with a coating 162. For example, the coating 162 may be a waterproofing agent or treatment. If the aerogel 150 is a silica aerogel, the aerogel 150 may be treated with a compound that may remove polar, hydrophilic functional groups (e.g., hydroxyl groups) from the surfaces of the aerogel 150. For instance, a silica aerogel may be treated with a compound such as hexamethyldisilazane, which may cause the aerogel 150 to have nonpolar, hydrophobic functional groups present on the surfaces of the aerogel 150 that are unreactive with water. While the example of hexamethyldisilazane has been given, it should be noted that there are many other suitable compounds that may be used to replace polar, hydrophilic functional groups with nonpolar, hydrophobic functional groups.

It should also be noted that the illustrated embodiment of the panel 124 may be thinner than the embodiment of the panel illustrated in FIG. 6 as well as typical double-walled panels that include forms of insulation other than aerogel. The reduced thickness of the panel due to the use of aerogel and the inclusion of only one panel wall may also allow for the HVAC units to be smaller and less heavy than HVAC units that include insulative materials other than aerogel.

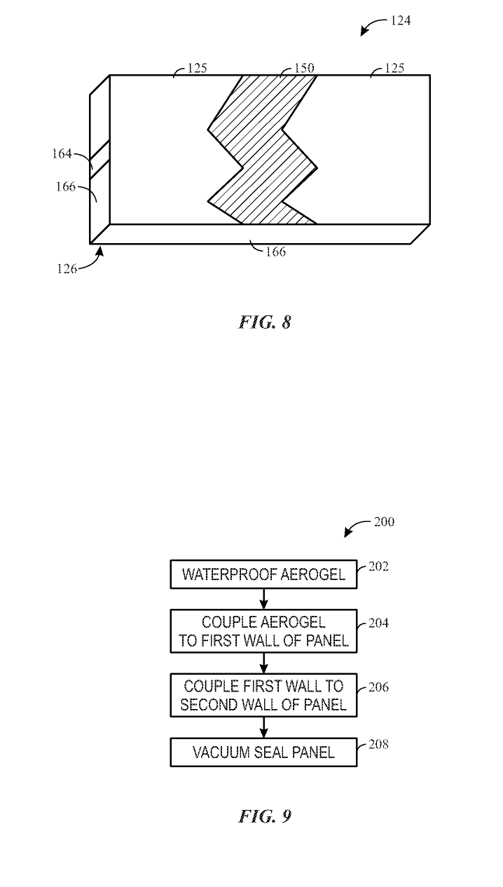

FIG. 8 is a perspective view of yet another embodiment of the panel 124 that may be included in the HVAC unit 12. More specifically, in the illustrated embodiment, a portion of the outer wall 125 is removed to show the aerogel 150 that is encased within the panel 124. In other words, the aerogel 150 is completely surrounded by the outer wall 125 and the inner wall 126. Additionally, the panel 124 may include a plug 164 through which the aerogel 150 may be inserted or injected into the panel 124. In other words, the plug 164 is an opening (e.g., between the inner wall 126 and the outer wall 125) that can be utilized to fill a space between the inner wall 126 and the outer wall 125 with the aerogel 150. Moreover, interior (i.e., the space enclosed between the inner wall 126 and the outer wall 125) may be vacuum sealed via the plug 164. Furthermore, the plug 164 may be sealed to the inner wall 126 and outer wall 125 (e.g., via a mechanical connection, or welding). The inner wall 126 and the outer wall 125 may also be sealed to one another via side walls 166 or directly to one another. Furthermore, in other embodiments, the outer wall 125 and the inner wall 126 may be formed as one piece.

Continuing with the drawings, FIG. 9 is a flow chart of a method 200 that may be used to assemble the panel 124. The steps of the method 200 may be performed in any suitable order. That is, in some embodiments, the steps of the method 200 may be performed in an order other than the order presented in FIG. 9.

At block 202, the aerogel 150 may be waterproofed. As discussed above, aerogel 150 may be treated with a waterproofing agent or certain compounds to make the aerogel 150 waterproof. For instance, if the aerogel 150 is a silica-based aerogel, the aerogel may be treated with a compound, such as hexamethyldisilazane, that may remove polar, hydrophilic functional groups (e.g., hydroxyl groups) from the surfaces of the aerogel.

At block 204, the aerogel 150 may be coupled to a first wall of the panel 124 (e.g., outer wall 125) used in HVAC unit 12. As discussed above, the aerogel 150 may be coupled to the first wall via an adhesive. Moreover, as discussed below with respect to block 206, coupling of the first wall to a second wall may cause the aerogel 150 to become coupled to the first wall.

At block 206, the first wall of the panel may be coupled to a second wall of the panel (e.g., inner wall 126). As discussed above, the first and second walls may be coupled to one another via mechanical fasteners or welding. Additionally, the aerogel may be disposed between and/or encased by two walls of the panel. However, in other embodiments, the panel 124 may not include a second wall.

At block 208, the panel may be vacuum sealed. For example, in embodiments of the panel 124 in which the aerogel 150 is disposed between and/or encased by two walls of the panel 124, a vacuum sealing process may be applied to the panel 124 to remove any air or other matter from the panel 124.

While the discussion of the present disclosure relates to panels of the HVAC unit 12, which may be a rooftop HVAC unit, it should be noted that panels with aerogel 150 may be used in any other suitable HVAC unit. For example, panels with aerogel may be used in HVAC units that are position on the ground and/or HVAC units used with residential buildings, such as the HVAC unit 58 of FIG. 3.

As discussed above, aerogel 150 may be used as an insulating material in panels 124 of HVAC units 12. Insulating the panels 124 with aerogel 150 reduces the weight of the HVAC units 12. Moreover, in embodiments in which the panels 124 are single-walled, there is an even greater reduction weight due to the panel 124 only including a single wall instead of two walls.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described (i.e., those unrelated to the presently contemplated best mode of carrying out the present disclosure, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, and air conditioning (HVAC) unit, comprising:
a cabinet having a boundary which defines an interior volume, certain HVAC components being situated within the interior volume; and
a panel which forms part of the boundary, wherein the panel comprises an aerogel material.

2. The HVAC unit of claim 1, wherein the aerogel material is coupled to the panel via an adhesive.

3. The HVAC unit of claim 1, wherein the panel comprises two walls, and the aerogel material is disposed between the two walls.

4. The HVAC unit of claim 3, wherein the aerogel material is coupled to the two walls via a mechanical fastener.

5. The HVAC unit of claim 1, wherein the aerogel material is completely encased within the panel.

6. The HVAC unit of claim 5, wherein the aerogel is vacuum sealed within the panel.

7. The HVAC unit of claim 1, wherein the aerogel material is waterproof

8. The HVAC unit of claim 1, wherein the panel comprises only one structural wall.

9. The HVAC unit of claim 1, wherein the HVAC unit is a rooftop HVAC unit.

10. The HVAC unit of claim 1, wherein the aerogel material comprises a silica aerogel.

11. The HVAC unit of claim 1, wherein the aerogel material comprises a metal oxide aerogel.

12. The HVAC unit of claim 1, wherein the aerogel material comprises a carbon aerogel.

13. The HVAC unit of claim 1, wherein the panel is made of galvanized steel.

14. The HVAC unit of claim 1, comprising a plurality of panels that comprises the panel and form a portion of the boundary.

15. A heating, ventilation, and air conditioning (HVAC) enclosure, comprising:
a panel, comprising:
a first structural wall having a first surface; and
an insulative material coupled to the first surface of the first structural wall, wherein the insulative material comprises an aerogel.

16. The enclosure of claim 15, wherein the panel comprises a second structural wall, wherein the aerogel is disposed between the first and second structural walls.

17. The enclosure of claim 16, wherein the first structural wall and the second structural wall are coupled to one another via a mechanical fastener.

18. The enclosure of claim 15, wherein the first structural wall defines an interior volume, and wherein the aerogel is disposed within the interior volume.

19. The enclosure of claim 15, wherein the first structural wall comprises an exterior wall the HVAC enclosure.

20. The enclosure of claim 15, wherein the first surface of the first structural wall is an interior surface of the first structural wall.

21. The enclosure of claim 15, wherein the panel is one of a plurality of panels, each panel of the plurality of panels comprises the aerogel, the plurality of panels defines an interior volume of the enclosure, and a heat exchanger is disposed within the interior volume of the enclosure.

22. A heating, ventilation, and air conditioning (HVAC) unit, comprising:
an enclosure comprising a plurality of panels, wherein the plurality of panels defines an interior volume, and each panel of the plurality of panels comprises an aerogel material coupled to the respective panel;
a condenser disposed within the interior volume of the enclosure;
an evaporator disposed within the interior volume of the enclosure, wherein the evaporator is coupled to the condenser and is configured to receive a refrigerant from the condenser; and
a fan disposed within the interior volume of the enclosure, wherein the fan is configured to draw environmental air into the HVAC unit.

23. The HVAC unit of claim 22, wherein a first panel of the plurality of panels comprises a single structural wall, wherein the aerogel material is coupled to a surface of the panel opposite an environment surrounding the enclosure.

24. The HVAC unit of claim 23, wherein the aerogel material comprises a waterproofing treatment.

25. The HVAC unit of claim 22, wherein a first panel of the plurality of panels comprises two structural walls, wherein the aerogel material is disposed between the two structural walls.

26. The HVAC unit of claim 25, wherein the two structural walls are coupled to one another via a mechanical fastener.
